(19) United States
(12) Patent Application Publication
(10) Pub. No.: US 2007/0092425 A1
(43) Pub. Date: Apr. 26, 2007

(54) Process for purifying inorganic materials

(75) Inventor: Robert Lloyd, Galston (AU)

Correspondence Address: NIXON & VANDERHYE, PC, 901 NORTH GLEBE ROAD, 11TH FLOOR, ARLINGTON, VA, 22203, US

(73) Assignee: ADVORTECH HOLDINGS PTY LTD., NEW SOUTH WALES (AU)

(21) Appl. No.: 10/554,987

(22) PCT Filed: Dec. 19, 2003
(86) PCT No.: PCT/AU03/01698

§ 371 Date: Nov. 28, 2006

(30) Foreign Application Priority Data
Dec. 20, 2002 (AU) 2002953499

(51) Int. Cl. C01B 33/08

(52) U.S. Cl. 423/342

(57) ABSTRACT

The invention relates to a process for purifying inorganic materials by treating the materials with a solution of hydrogen fluoride in aqueous hydrofluorosilicic acid. The process involves treating an inorganic material containing at least two species, to at least partially separate a first species contained in the material from a second species contained in the material, and comprises treating the material with a fluorine acid solution comprising aqueous hydrofluorosilicic acid and hydrofluoric acid (HF), such that the first species is converted to a product selected from the group consisting of a fluoride, a fluorosilicate and mixtures thereof, and such that the second species is at least partly unreacted, and separating the second species from the product.

### TECHNICAL FIELD

This invention relates to a process for purifying inorganic materials by treating the materials with a solution of hydrogen fluoride in aqueous hydrofluorosilicic acid.

### BACKGROUND OF THE INVENTION

There is a need for processes that are relatively simple and can be used to remove impurities from inorganic materials, such as metal ores that contain metal oxides as their predominant component. The presence of impurities in metal ores can be undesirable in that they are detrimental to processes that are used to recover the desired metal or metals from the metal ore.

U.S. Pat. No. 4,780,112 describes a process for treating carbon to reduce the ash therein. The process involves treating the carbon with an aqueous solution of hydrofluorosilicic acid (H₂SiF₆) and hydrofluoric acid (HF), whereby metal oxides in the carbon are converted to metal fluorides and/or metal fluorosilicates, from which carbon is then separated.

Surprisingly, however, it has been found by the present inventor that at appropriate concentrations of hydrogen fluoride and hydrofluorosilicic acid in the treating solution, some inorganic substances are substantially unreactive with the treating solution, while other materials present react and dissolve. This selectivity of reaction can be exploited to free inorganic materials that consist predominantly of the unreactive substances, from other materials which react with the treating solution under the conditions employed. Alternatively, in a situation in which the predominant species is reactive with the treating solution, the selectivity of reaction can be exploited to dissolve the predominant species and thereby remove it selectively from unreactive impurities present.

### SUMMARY OF THE INVENTION

In a first aspect of the invention there is provided a process for treating an inorganic material containing at least two species, to at least partially separate a first species contained in the material from a second species contained in the material, comprising:
treating the material with a fluorine acid solution comprising aqueous hydrofluorosilicic acid and hydrofluoric acid (HF), such that the first species is converted to a product selected from the group consisting of a fluoride, a fluorosilicate and mixtures thereof, and such that the second species is at least partly unreacted, and
separating the second species from the product.

The first and the second species and the product may each be single compounds or they may be mixtures, or one may be a mixture and two may be single compounds, or two may be mixtures and one may be a single compound. The first and the second species may be insoluble in water. They may have a solubility at saturation at 25° C. in pure water at pH 7 of less than about 10⁻³ M, or less than about 10⁻⁴, 10⁻⁵, 10⁻⁶ or 10⁻⁷ M, or of the order of about 10⁻³, 10⁻⁴, 10⁻⁵, 10⁻⁶ or 10⁻⁷ M. They may be for example chalcogenides, for example oxides, sulfides, selenides or tellurides, or they may be some other species or they may be mixtures of these. The first species is soluble in the fluorine acid solution and the second species is insoluble in the fluorine acid solution. The first species may comprise for example a compound of aluminium, antimony, silver, cobalt, copper, tin, tantalum, zinc, iron, silicon or a trace element, for example yttrium, selenium and osmium. The second species may comprise for example a compound of titanium, iron, bismuth, calcium, chromium, molybdenum or uranium. For the purpose of this specification, where reference is made, for example, to an oxide, said oxide may be any or all of the possible oxides, and hydrates thereof. For example, iron oxide may refer to FeO, Fe₂O₃, Fe₃O₄, hydrates thereof (for example Fe(OH)₂, Fe(OH)₃) and mixtures of any two or more of these species, and titanium oxide may refer to TiO, TiO₂, Ti₂O₃ or Ti₃O₅, or to hydrates and/or mixtures thereof. The fluorine acid solution may be saturated with respect to hydrofluorosilicic acid. That is, no more hydrofluorosilicic acid will dissolve in it. The fluorine acid solution may be between about 50 and about 100% saturated with respect to hydrofluorosilicic acid, or between about 60 and about 100% or between about 70 and about 100% or between about 80 and about 100% or between about 90 and about 100% saturated with respect to hydrofluorosilicic acid, or may be about 50, 60, 70, 80, 90, 95 or 100% saturated with respect to hydrofluorosilicic acid. The mean particle size of the inorganic material may be reduced to less than about 2 mm prior to reaction with the fluorine acid solution, or it may be less than about 1.75, 1.5, 1.25, 1, 0.75 or 0.5 mm. The mean particle size may be reduced to between about 0.5 and about 2mm, or between about 0.75 and about 1.75 mm or between about 1 and about 1.5 mm, and may be reduced to about 0.5, 0.75, 1, 1.25, 1.5, 1.75 or 2 mm. For the purpose of this specification the particle size is taken to be the largest dimension of an individual particle. The separating may be by a method selected from the group consisting of settling, filtration, centrifugation, and any combination of these methods. The process is conducted so that the second species is at least partly unreacted. The process is conducted so that the second species is unreacted or substantially unreacted. The second species may be more than about 80% unreacted, or more than about 85, 90, 95, 96, 97, 98, 99, 99.5 or 99.9% unreacted, or may be about 80, 85, 90, 91, 92, 93, 94, 95, 96, 97, 98, 99, 99.5, 99.6, 99.7, 99.8, 99.9 or 100% unreacted.

The inorganic material is treated with a sufficient amount of fluorine acid solution to sufficiently wet the material and for a sufficient time and under suitable conditions (particularly of temperature and pressure) to enable the first species to be converted to the product selected from the group consisting of a fluoride and a fluorosilicate and mixtures thereof and such that the second species is at least partly unreacted. For example, the wt:wt ratio of fluorine acid solution:inorganic material may be in the range of 0.8:1 to 10:1, or 1:1 to 9:1, or 1:1 to 8:1, or 1:1 to 7:1, or 1:1 to 6:1, or 1:1 to 5:1, or 1:1 to 4:1, or 1:1 to 3: 1, or 1:1 to 2:1 to 1:1 to 1:1.5. The wt:wt ratio of fluorine acid solution:inorganic material may be in about 0.8, 1, 1.25, 1.5, 1.75, 2, 2.25, 2.5, 2.75, 3, 3.5, 4, 4.5, 5, 5.5, 6, 6.5, 7, 7.5, 8, 8.5, 9, 9.5, 10, 10.5, 11, 15, 20, 25 or more. The molar ratios of HF to the first species and of fluorosilicic acid to the first species may independently be between about 20:1 and about 1: 1, or may be between about 10:1 and about 1:1 or between about 9:1 and about 1.5:1 or between about 8:1 and about 2:1 or between about 7:1 and about 2.5:1 or between about 6:1 and about 3:1, or may be about 1:1, 1.5:1, 2:1, 2.5:1, 3:1, 3.5:1, 4:1, 4.5:1, 5:1, 6:1, 7:1, 8:1, 9:1, 10:1, 15:1 or 20:1 or it may be greater than 20:1. The treating may be conducted at a temperature in the range from about 1° C. to about 99° C., about 5° C. to about 95° C., about 10° C. to about 90° C. about 20° C. to about 85° C., about 30° C. to about 80° C., about 40° C. to about 80° C., about 50° C to about 80° C., about 60°C. to about 80° C., about 10° C. to about 80° C., about 10° C. to about 70° C., about 10° C. to about 60° C., about 10° C. to about 50° C., about 10° C. to about 40° C., about 10° C. to about 30° C., about 10° C. to about 25° C., about 10° C. to about 20° C., about 10° C. to about 15° C. to about 12° C. to about 40° C., about 15° C. to about 40° C., about 15° C. to about 35° C., about 15° C. to about 30° C., about 15° C.to about 25° C., about 15° C. to about 25° C. or about 15° C. to about 20° C., for example. The treating may be conducted at about 1, 2, 3, 4, 5, 6, 7, 8, 9, 10, 11, 12, 15, 18, 20, 23, 25, 27, 30, 32, 35, 37, 40, 45, 50, 55, 60, 65, 70, 75, 80, 85, 90, 95, or 99° C., for example. The treating may be conducted at a pressure in the range from about 0.9 atmosphere to about 5 atm, about 1 atm to about 4 atm, about 1 atm to about 3 atm, about 1 atm to about 2 atm, about 1 atm to about 1.5 atm about 1 atm to about 1.3 atm, about 1 atm to about 1.2 atm about 1 atm to about 1.1 atm, about 2 atm to about 5 atm, about 3 atm to about 5 atm, about 3.5 atm to about 5 atm, or about 3.5 atm to about 4.5 atm, for example. The treating may be conducted at about 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.5, 4, 4.5, 5 or more atmospheres, for example. The treating may be conducted under conditions of standard temperature and pressure, for example.

In a first embodiment, the HF concentration in the fluorine acid solution is at least about 15% by weight based on the total weight of HF and water present. The concentration may be at least about 16, 17, 18, 19, 20, 25, 30, 35, 40, 45 or 50%, or it may be between about 15 and about 50% or between about 20 and about 45% or between about 25 and about 40% or between about 30 and about 35%, or it may be about 15, 16, 17, 18, 19, 20, 25, 30, 35, 40, 45 or 50% or it may be greater than about 50% by weight based on the total weight of HF and water present. In this embodiment, the first species may be selected from the group consisting of silica, alumina and mixtures thereof, and does not comprise iron oxide.

In a second embodiment, the HF concentration in the fluorine acid solution is less than about 15% by weight based on the total weight of HF and water present. The HF concentration may be less than about 14, 13, 12, 11, 10, 9, 8, 7, 6, 5, 4, 3, 2, 1, 0.5 or 0.1%, or may be between about 0.1 and about 15% or between about 0.5 and about 15% or between about 1 and about 15% or between about 2 and about 14 % or between about 3 and about 13% or between about 4 and about 12 % or between about 5 and about 11% or between about 5 and 10%, or it may be about 0.1, 0.5, 1, 2, 3, 4, 5, 6, 7, 8, 9, 10, 11, 12, 13, or 14% by weight based on the total weight of HF and water present. In this embodiment, the first species may be selected from the group consisting of silica, iron oxides, alumina and mixtures of at least two of these.

In a third embodiment, the second species represents greater than about 50% by weight of the material. The second species may represent greater than about 55, 60, 65, 70, 75, 80, 85, 90, 95, 96, 97, 98, 99, 99.5 or 99.9% by weight of the material, or between about 50 and about 99.9 or between about 60 and about 99.5 or between about 70 and about 99 or between about 80 and about 95 or between about 85 and about 95% by weight of the material, or may represent about 50, 55, 60, 65, 70, 75, 80, 85, 90, 95, 96, 97, 98, 99, 99.5 or 99.9% by weight of the material. In a first example, the second species comprises iron oxide, and the process is a process for at least partially purifying the iron oxide, and the first species is silica and the concentration of HF in the fluorine acid solution is at least 15% by weight based on the total weight of HF and water present, based on the total weight of the HF and water. In a second example, the second species comprises titanium oxide, and the process is a process for at least partially purifying the titanium oxide and the first species comprises at least one species selected from the group consisting of iron oxide, silica and mixtures thereof, and the concentration of HF in the fluorine acid solution is less than 15% based on the total weight of the HF and water present. In a third example, the second species comprises titanium oxide and iron oxide, and the concentration of HF in the fluorine acid solution is at least 15% by weight, based on the total weight of the HF and water present.

In a fourth embodiment, the process additionally comprising washing the second species with aqueous hydrofluorosilicic acid after the separating. The process may additionally comprise heating the second material, initially to between about 70° C. and about 140° C., or to between about 80° C. and about 140° C. or to between about 90° C. and about 140° C. or to between about 100° C. and about 140° C. or to between about 110° C. and about 140° C. or to between about 120° C. and about 140° C. or to between about 125° C. and about 135° C., or to about 70, 80, 90, 100, 110, 120, 125, 130, 135 or 140° C., and then to between about 250° C. and about 400° C., or to between about 250° C. and about 350° C. or to between about 275° C. and about 325° C., or to about 250, 275, 300, 325, 350, 375 or 400° C. after the washing. In this embodiment, HF and SiF₄ produced by the heating may be scrubbed by conventional water wash means. The HF and SiF4 may be recycled for reuse in the process.

In a fifth embodiment, the inorganic material contains silica and the process releases SiF₄, said process additionally comprising the step of adding the SiF4 to water in a spray tower to produce aqueous H₂SiF₆ and silica. The process may additionally comprise at least one of the steps of removing the silica from the spray tower, crystallising the silica, and using the aqueous H₂SiF₆ which leaves the tower to wash inorganic material that has been treated by the process. The process may additionally comprise the step of boiling the aqueous H₂SiF₆ used to wash the inorganic material in a still to separate HF, SiF4 and water vapour from bottoms. The bottoms may be removed from the still for a procedure selected from the group consisting of disposal and further processing for recovery of useful metals. For example, the bottoms may contain alumina, and the bottoms may be heated to a sufficient temperature to sublime aluminium trifluoride (above about 1200° C.). In another example, the bottoms are heated in the presence of water under conditions suitable for at least partial hydrolysis of said bottoms. The vapours from the still may be dried by contacting the vapours with sufficient of a material to remove the water vapour present, said material being substantially unreactive with HF and SiF₄, and being capable of absorbing moisture. The material may be selected from the group consisting of aluminium fluoride and calcium fluorosilicate. The ratio of the amount of water vapour in the vapours to the amount of the material may be between about 2:1 and about 1:5, or between about 1.5:1 and about 1:4 or between about 1:1 and about 1:3 or between about 1:1 and about 1:2, or maybe about 2:1 or 1.5:1 or 1:1 or 1:1.5 or 1:2 or 1:2.5 or 1:3 or 1:3.4 or 1:4 or 1:4.5 or 1:5 on a molar basis.

In a second aspect of the invention there is provided a process for treating an inorganic material containing at least two species, to at least partially separate a first species contained in the material from a second species contained in the material, comprising:
treating the material with a fluorine acid solution comprising at least one a fluorine-containing acid and at least one fluoride salt, such that the first species is converted to a soluble product, and such that the second species is at least partly unreacted, and
separating the second species from the product.

In a third aspect of the invention there is provided a process for treating an inorganic material containing at least two species, to at least partially separate a first species contained in the material from a second species contained in the material, comprising:
a) treating the material with a first fluorine acid solution comprising aqueous hydrofluorosilicic acid,
b) treating the material with a second fluorine acid solution comprising hydrofluoric acid (HF),
   such that the first species is converted to a product selected from the group consisting of a fluoride, a fluorosilicate and mixtures thereof, and such that the second species is at least partly unreacted, and
c) separating the second species from the product.

Steps a) and b) may be conducted either in the order a) followed by b) or in the order b) followed by a).

A product when prepared by any of the processes of the invention is also included within the scope of the invention.

In a fourth aspect of the invention there is provided a system for treating an inorganic material containing at least two species, to at least partially separate a first species contained in the material from a second species contained in the material, comprising:
means for treating the material with a fluorine acid solution comprising aqueous hydrofluorosilicic acid and hydrofluoric acid (HF), such that the first species is converted to a product selected from the group consisting of a fluoride, a fluorosilicate and mixtures thereof, and such that the second species is at least partly unreacted, and
means for separating the second species from the product.

In a fifth aspect of the invention there is provided a system for treating an inorganic material containing at least two species, to at least partially separate a first species contained in the material from a second species contained in the material, comprising:
means for treating the material with a fluorine acid solution comprising at least one a fluorine-containing acid and at least one fluoride salt, such that the first species is converted to a soluble product, and such that the second species is at least partly unreacted, and
means for separating the second species from the product.

In a sixth aspect of the invention there is provided a system for treating an inorganic material containing at least two species, to at least partially separate a first species contained in the material from a second species contained in the material, comprising:
a) means for treating the material with a first fluorine acid solution comprising aqueous hydrofluorosilicic acid,
b) means for treating the material with a second fluorine acid solution comprising hydrofluoric acid (HF),
   such that the first species is converted to a product selected from the group consisting of a fluoride, a fluorosilicate and mixtures thereof, and such that the second species is at least partly unreacted, and
c) means for separating the second species from the product

There is also provided a system according to the fourth, fifth or sixth aspect of the invention when used for performing any of the processes of the invention.

### DISCLOSURE OF THE INVENTION

This invention concerns a process for the purification of an impure inorganic material by the use and manipulation of fluorine containing acids in such mixtures and concentrations to allow at least some of the impurities present in the material to be separated from the other species present. The process involves manipulation of fluorine containing acids in such mixtures and concentrations to cause at least one species present in the material to dissolve while at least one other species remains at least partially undissolved.

This invention therefore provides a process for treating an inorganic material containing at least two species, to at least partially separate at least one species contained in the material from one or more other species contained in the material, comprising treating the material with a fluorine acid solution comprising aqueous hydrofluorosilicic acid and HF, such that at least some of one or more of the species present in the inorganic material is converted to metal fluoride and/or metal fluorosilicate while at least one other species is at least partly unreacted, and separating the unreacted species from the metal fluoride(s) and/or metal fluorosilicate(s) produced by the treatment.

As used herein, the term “inorganic material” refers to any mixture of substances that are predominantly, but not necessarily exclusively, inorganic.

As used herein, the word “comprising” and variants on it such as “comprises”, “comprise”, shall be understood to mean that the feature or features referred to are included, but that other features are not necessarily excluded from being present also.

A fluorine acid solution for use in the process of this invention can be prepared from an aqueous solution of hydrofluorosilicic acid (H₂SiF₆+H₂O) to which anhydrous hydrofluoric acid (HF) is added so that both these reactive acids are in one solution. Alternatively the fluorine acid may be prepared from an aqueous solution of hydrofluoric acid and an aqueous solution of HF. Although both these acids are in the one solution, they act independently in the process of the invention due to the fact that the two reactive fluorides do not chemically combine. The fluorine acid solution is preferably saturated with respect to hydrofluorosilicic acid. That is, no more hydrofluorosilicic acid will dissolve in it. The concentration of hydrofluorosilicic acid in a saturated solution is 32% by weight, expressed as a percentage of the total weight of water and hydrofluorosilicic acid present. Fluorine acid solutions that are not saturated may also be used, but under the conditions of the processes of the invention, they tend to become saturated as silica, which is commonly present in the inorganic material to be treated, is dissolved by the fluorine acid solution.

Furthermore, the use in the process of an aqueous solution that is saturated with respect to hydrofluorosilicic acid permits the separation of HF from SiF₄ in the gaseous phase, as described herein below.

The present invention is based on the surprising discovery by the inventor that when the concentration of hydrogen fluoride in the fluorine acid solution is above a certain value, some inorganic species become unreactive to the fluorine acid solution. For example, iron oxide, though reactive with the fluorine acid solution if the HF concentration is below about 15% by weight (based on the total weight of HF and water present; that is, disregarding the amount of hydrofluorosilicic acid present) becomes substantially unreactive when the HF concentration is above about 15% by weight (on the same basis.) Other substances that may be present, such as silica and alumina, remain reactive with the fluorine acid solution at essentially all concentrations of HF. Other oxides that may be present may become unreactive with the fluorine acid solution at other HF concentrations, which may be readily determined by a person of ordinary skill in the art, given the teaching herein. Titanium oxide, if present, is substantially unreactive with the fluorine acid solution regardless of the HF concentration. Inorganic fluorides that may be present in the inorganic material to be treated are dissolved by the fluorine acid solution in the form of a metal fluorosilicate.

Thus, typical compositions of fluorine acid solutions of this invention are:

| | |
|---|---|
| for treating inorganic materials to remove iron | 30 parts H₂SiF₆, |
| oxides | 63 parts water, |
| | 7 parts HF or less |
| for treating inorganic materials to remove silica | 29 parts H₂SiF₆, |
| and/or alumina but not iron oxides | 61 parts water, |
| | 11 parts HF, |
| | or |
| | 27 parts H₂SiF₆ |
| | 58 parts water, |
| | 15 parts HF |
| | or even relatively more |
| | HF. |

In these compositions, the weight ratio of H₂SiF₆ to water is 32:68 and the amount of HF is altered depending on the inorganic material to be treated in the process of the invention.

In each of these compositions described above, the amounts are expressed as parts by weight per 100 parts by weight of the fluorine acid solution.

Optionally the fluorine acid solution is prepared by adding anhydrous hydrogen fluoride gas to a saturated aqueous solution of hydrofluorosilicic acid.

Preferably, in the process of the invention the inorganic material is reduced to approximately 2 mm minus prior to reaction with the fluorine acid solution.

Usually, but not necessarily, in the process of the present invention the species in the inorganic material that is/are unreactive with the fluorine acid solution under the conditions employed in the process will be the predominant species in the material and it will be the aim of the user of the process to obtain the predominant species in purified form for further processing, such as metal recovery from the species.

In one form of the process of the invention, the inorganic material consists predominantly of iron oxides with lesser amounts of one or more impurities, and the process is a process for at least partially purifying the iron oxides by selectively dissolving at least some of the impurities present. Typically the iron oxide includes silica as impurity. In this form of the process, the concentration of HF in the fluorine acid solution is at least 15% by weight, based on the total weight of the HF and water. Greater concentrations of HF, such as 20%, 25%, 30%, 35%, 40%, 45%, 50% or more, based on the total weight of the HF and water, may also be used.

In another form of the process of the invention, the inorganic material consists predominantly of titanium oxide with lesser amounts of one or more impurities, and the process is a process for at least partially purifying the titanium oxide by selectively dissolving at least some of the impurities present. Typically the titanium oxide includes silica as impurity. In this form of the process, the concentration of HF in the fluorine acid solution need not be as high as where the inorganic material consist predominantly of iron oxides, especially if iron oxides are present and are to be removed by the process. In this case, the concentration of HF is less than 15%, more usually less than 10% by weight, based on the total weight of the HF and water, and may be less, such as 1%, 2%, 3%, 4%, 5%, 6%, 7%, 8% or 9% by weight, based on the total weight of the HF and water.

In a further form of the process of the invention, the inorganic material consists predominantly of titanium oxide (titania) and iron oxide with lesser amounts of one or more impurities, and the process is a process for at least partially purifying the titania and iron oxides by selectively dissolving at least some of the impurities present. Typically the titania and iron oxide include silica as impurity. In this form of the process, the concentration of HF in the fluorine acid solution is at least 15% by weight, based on the total weight of the HF and water. Greater concentrations of HF, such as 20%, 25%, 30%, 35%, 40%, 45%, 50% or more, based on the total weight of the HF and water, may also be used.

Conveniently, the inorganic material is first treated with the fluorine acid solution in a stirred reactor and is then further treated with the fluorine acid solution in at least one tubular reactor to ensure continuous contact between the fluorine acid solution and the material. It is preferred, but not essential, that the mixture is ultrasonically agitated as it is passing through the tubular reactor. Preferably the pressure in the stirred reactor is maintained at up to about 150 kPa (for example in the range 75 kPa to 150 kPa or in the range 1001 Pa-150 kPa) and the pressure in the tubular reactor is applied and/or maintained in the range 350-500 kPa (or 350-450 kPa, or 350-400 kPa or 400-500 kPa, for example), and the temperature is maintained at 70° C. (or in the range 65-80° C., for example). However, the reactions still occur at useful rates at lower temperatures and pressures, including ambient temperatures and pressures.

After treatment with the fluorine acid solution, the unreacted and undissolved residue is separated from the aqueous phase by any convenient means such as by settling, filtration, centrifugation, or any combination of these methods.

Conveniently, the separated undissolved material is washed with aqueous hydrofluorosilicic acid to remove metal fluorides and/or metal fluorosilicates from the surface thereof.

Preferably the treated undissolved material after washing with H₂SiF₆ is heated initially to 70° C.-140° C., preferably 130° C. and then to between 250° C. and 400° C., preferably about 300° C. to remove hydrofluorosilicic acid on the surface, which comes off as HF and SiF₄. Optionally, the HF and SiF₄ gases are scrubbed by conventional water wash means for recovery of HF and conversion of SiF₄ with water to SiO₂ and HF. More usually, however, the HF and SiF₄ are recycled for reuse in the process.

In one form of the invention the inorganic materials contain silica. The process of this form of the invention thus releases SiF₄ gas. Conveniently, the SiF₄ gas is added to water in a spray tower to produce aqueous H₂SiF₆ and silica. The silica is preferably removed from the spray tower and crystallised, while the aqueous H₂SiF₆ which leaves the tower is conveniently used to wash inorganic material that has been treated by the process of the present invention, in order to remove dissolved metal fluorides from it, as described above. Aqueous phase separated from the treated inorganic materials in this washing step may conveniently be transferred to a still in which the aqueous phase is boiled to cause HF, SiF₄ and water vapour to be evolved. Suitably, HF and SiF₄ vapours separated from the treated material in a heating step, as described above, may be directed to this still also, or they may be combined with the vapours removed from the still. Bottoms from the still, which consist of a concentrated solution and/or suspension of metal fluorides, may be removed from the still for disposal and/or further processing for recovery of useful metals, as desired.

In a preferred aspect of this form of the process, vapours from the still, containing water vapour, may be dried by any suitable process, so that the fluorine-containing components may be reused in the process of the present invention or elsewhere. A convenient drying process involves contacting the vapours with sufficient of an anhydrous metal fluoride, such as aluminium fluoride, to remove the water vapour present. The anhydrous metal fluoride may be regenerated after use, by heating it. Any anhydrous metal fluoride or other anhydrous material can be used for this drying step provided the material has two properties: it must be substantially unreactive with HF and SiF₄, and it must be capable of absorbing moisture. Aluminium fluoride is preferred for this purpose. An example of another material that may be used is calcium fluorosilicate, CaSiF₆.

In one form of the process of the present invention, gases containing HF and SiF4 are contacted with aqueous fluorine acid that has been used for treating inorganic materials in accordance with the process of the invention. It will be appreciated that as a result of being contacted with the inorganic material, the aqueous fluorine acid becomes relatively depleted in hydrogen fluoride. By treating it with gases containing HF and SiF₄, the hydrogen fluoride content, and optionally the H₂SiF₆ content (depending on the concentration of H₂SiF₆ in the fluorine acid solution), can be replenished. If the aqueous fluorine acid is essentially saturated in SiF₄ (that is, if it is about 32% w/w H₂SiF₆), SiF₄ that is contacted with the fluorine acid solution is substantially unaffected. In this situation, after gases containing HF and SiF₄ have been contacted with aqueous fluorine acid in this way, a vapour stream consisting essentially of SiF₄ remains, which may be directed to a water spray tower for hydrolysis as described above.

Solids removed from the bottoms of the still may be treated in various ways to recover useful materials therefrom. For instance, aluminium oxide is a common impurity in inorganic materials that is dissolved from them in the process of the present invention. Solids removed from the bottoms of the still may be heated to recover the aluminium values dissolved from inorganic materials by the process of the present invention, since at sufficient temperature (in excess of 1200° C.) aluminium trifluoride sublimes and may be collected by condensing the sublimate. Similarly, where the inorganic materials to be treated contain compounds of arsenic, the compounds of arsenic are dissolved by the process of the present invention and arsenic values accumulate in the solids in the still bottoms. Additionally, or alternatively, the still bottoms may be heated in the presence of water to cause at least some to be hydrolysed and liberate HF gas, which may be recovered and recycled to other parts of the process.

### BRIEF DESCRIPTION OF THE DRAWING

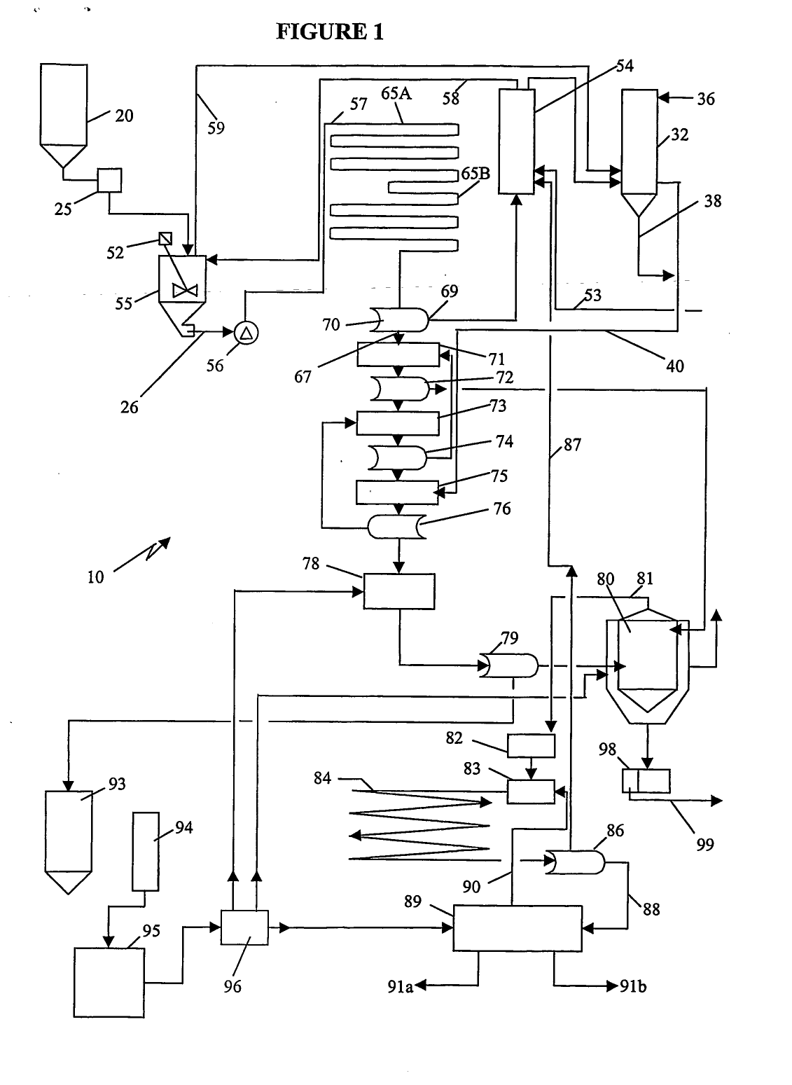

A preferred embodiment of this invention will now be described by way of example with reference to FIG. 1 which is a block diagram of a system for treating inorganic materials, incorporating a process of the present invention.

### BEST METHOD OF CARRYING OUT THE INVENTION

FIG. 1 illustrates in schematic block diagram form a system 10 for treating inorganic material, incorporating a process in accordance with the present invention.

Referring to FIG. 1, system 10 includes hopper 20 for holding impure inorganic material which has been reduced to granular form, preferably less than about 2 mm in particle size. Associated with hopper 20 is feed unit 25 for conveying the inorganic material from hopper 20 to gassing reactor 55.

Gassing reactor 55 is positioned to receive the inorganic material from feed unit 25. Gassing reactor 55 is also equipped with line 58 to admit an aqueous fluorine acid solution of approximately 32%w/w H₂SiF₆ and hydrogen fluoride from a hydrogen fluoride absorber 54. The concentration of hydrogen fluoride in this aqueous solution is controlled to be above a concentration at which some, but not all, metal oxides and other materials present in the inorganic material are substantially unreactive with the aqueous solution. Gassing reactor 55 may be a flow through reactor or a stirred or rotating reactor. Typically, gassing reactor 55 is a stirred reactor as shown in FIG. 1, in which it is shown equipped with stirrer 52. Reactor 55 is also equipped with gas offtake line 59 which communicates with spray tower 32. It is also equipped with line 26 for transfer of the contents of reactor 55, after the inorganic material has been in contact with the aqueous fluorine acid solution for a suitable time, via pump 56 and line 57 to a two-stage tubular reactor 65A, 65B. One or both of stages 65A and 65B are capable of being agitated ultrasonically.

The distal end of reactor 65B discharges into separator 70 which is equipped with solid and liquid takeoffs 67 and 69 respectively. Liquid takeoff 69 communicates with HF absorber 54, and solids takeoff 67 discharges solids to a system of mixers and separators for washing. Separator 70 may be any suitable separator for separating solids from liquids. It is not critical to the process of the invention that the solids be substantially free of liquid, but it is preferable from the point of view of process efficiency that the separated liquids be substantially free from solids.

The mixer/separator system consists of three mixing tanks 71, 73 and 75 and three separators, such as centrifuges or belt filters, 72, 74 and 76 arranged so that solids can flow sequentially from mixing tank 71 to separator 72, then to mixing tank 73 followed by separator 74, then to mixing tank 75 and separator 76. The system is arranged so that aqueous phase moves essentially counterflow to the solids.

The solids exit of final separator 76 is connected to a drying system which consists of drier 78 and solid/gas separator 79. Separator 79 has a vapour off-take that communicates with a still 80, which is equipped with a jacket heater, vapour outlet 81 and a bottom outlet leading to solids separator 98. The liquid exit of the mixer/separator system is from separator 72 and also communicates with still 80.

Vapour outlet 81 of still 80 is connected via pressure fan 82 and mixer 83 to gas dehydration reactor 84. Mixer 83 is also equipped with a connection (not shown) whereby hot gases can be admitted to it. Downstream of dehydration reactor 84 is separator 86 with anhydrous gas takeoff 87 which is connected to HF absorber 54. Separator 86 is also connected to solids transfer line 88 which communicates with fluoride drier 89. Fluoride drier 89 is equipped with water removal lines 91a, 91b nd fluoride supply line 90 for transferring substantially anhydrous metal fluoride(s) from drier 89 to mixer 83.

As described above, reactor 55 is connected via line 59 to spray tower 32. Spray tower 32 is also connected to HF absorber 54 and it is further equipped with water inlet 36, solids discharge line 38 and hydrofluorosilicic acid removal line 40 that is connected to mixer 75.

HF absorber 54 is initially charged with 32% w/w aqueous hydrofluorosilicic acid and it communicates with outlet 69 of separator 70 as well as with separator 86 via anhydrous gas takeoff 87 as described above. Liquid can be removed from HF absorber 54 by line 58 for transfer to reactor 55. Vapours leaving HF absorber 54 can be passed to spray tower 32. HF absorber 54 is also equipped with HF makeup line 53.

When system 10 is in use, inorganic material from hopper 20 are transferred via feed unit 25 to reactor 55. Suitably, the transfer of inorganic material via feed unit 25 is by a system of a plurality of disks within a tube or pipe, the disks being approximately the internal diameter of the tube or pipe and connected by a cable whereby they can be drawn through the tube or pipe. A suitable system is marketed under the name “Floveyer” by GPM Australia Pty Ltd of Leichhardt, New South Wales. The transfer of material may be continuous or batchwise. Also supplied to reactor 55 is aqueous fluorine acid solution, from HF absorber 54 via line 58.

Inorganic material are contacted with the aqueous H₂SiF₆ and HF in reactor 55 for a time of typically about 10 to 20 minutes, more typically about 15 minutes. Reactor 55 is typically maintained at a pressure in the range of about 100-135 kPa and a temperature of about 70° C. Reactions occurring in reactor 55 generate metal fluorides which are soluble under the conditions used. Where silica is present in the inorganic material, which is commonly the case, the reactions generate silicon tetrafluoride which, depending on the concentration of the hydrofluorosilicic acid in the fluorine acid solution, may be partially hydrolysed or not hydrolysed at all. Thus at least some of the silicon tetrafluoride is evolved as a gas. The SiF₄ gas, and/or any other vapours generated in reactor 55, is removed from reactor 55 via line 59.

From reactor 55 the mixture of the inorganic material and aqueous fluorine acid solution is passed via pump 56 and line 57 to first stage tubular reactor 65A and thence to second stage 65B. In the tubular reactor, slower reactions and dissolution reaction processes, such as reaction of inorganic fluorides with the fluorine acid solution, proceed essentially to completion. The temperature in tubular reactor 65A, 65B is typically about 70° C. and the pressure is typically from 350 to 500 kPa. In first stage reactor 65A or second stage reactor 65B, or both, the suspension of inorganic material in aqueous acid may optionally be agitated ultrasonically, sufficiently for intimate contact of the aqueous fluorine acid with the inorganic material. A slurry of solids in aqueous hydrofluorosilicic acid and HF discharges to separator 70 where aqueous acid is removed, leaving a solids stream, still containing appreciable amounts of aqueous fluorine acid, to be transferred to the washer/separator system. It will be appreciated that the aqueous stream leaving separator 70 is depleted of HF, relative to the fluorine acid solution entering reactor 55 via line 58.

In the washer/separator system, solids are washed with aqueous hydrofluorosilicic acid which flows through the system in the opposite direction to the direction of flow of the solids. That is, the fresh supply of aqueous hydrofluorosilicic acid is supplied from hydrolyser 32 to mixing tank 75 where it mixes with the solids and is separated in separator 76. From separator 76 the aqueous phase is transferred to mixing tank 73 where it is mixed with solids entering that mixing tank, and separated therefrom in separator 74. The aqueous phase separated in separator 74 is transferred to mixing tank 71 where it is mixed with solids leaving separator 70. The solids and liquids in mixing tank 71 are separated in separator 72, the solids being transferred to mixing tank 73 and the liquids being transferred to still 80. Solids leaving separator 76 are thus washed solids, and liquid leaving separator 72 is relatively impure.

Solids leaving the final separator 76 in the sequence of vessels are admitted to drier 78. The solids enter drier 78 where they are balked, typically at about 300° C., to remove any remaining hydrofluorosilicic acid from the surface of the solids. The hydrofluoro-silicic acid is removed as gaseous hydrogen fluoride and silicon tetrafluoride, together with steam, which gases are directed to still 80 after the gases and the dried solids are separated in separator 79. Dried solids exiting separator 79 are purified inorganic materials which are suitable for further processing such as smelting, using existing technologies. As shown in FIG. 1, they are transferred to storage bin 93. System 10 further includes fuel storage container 94 from which dried carbonaceous fuel can be supplied to furnace and gas turbine system 95. Suitably, the dried carbonaceous fuel may be obtained by the process of U.S. Pat. No 4,780,112. Hot exhaust gases leaving furnace and gas turbine system 95 may be passed via manifold 96 to drier 78, still 80 and drier 89 for heating them.

Aqueous phase removed from separator 70 is passed to HF absorber 54 where gases from separator 86 are admitted for absorption of HF to regenerate the fluorine acid solution to be supplied to reactor 55. Any silicon tetrafluoride in gases leaving separator 86 which is unaffected by contact with the aqueous phase in HF absorber 54 leaves HF is absorber 54 to be passed to hydrolyser 32. In hydrolyser 32, water is added from inlet 36 in sufficient amount to produce aqueous H₂SiF₆ of the desired concentration for use in reactor 55. Silica is also generated in hydrolyser 32 and is removed via a bottom outlet and line 38.

Aqueous acid leaving the washer/separator system at separator 72 is transferred to 20 still 80 where it is heated to sufficient temperature (typically 105 to 110° C.) to cause hydrogen fluoride and silicon tetrafluoride gases to be liberated from the aqueous solution and any metal fluorides and metal fluorosilicates that had been contained in the aqueous phase to separate out as solids. It will be appreciated that the pressure difference across fan 82 will affect the pressure in still 80 and hence its temperature. The separated solids 25 are removed from still 80 via level control separator 98 and discharge line 99. Still 80 is typically heated by exhaust gas from gas turbine 95. Vapours from mixing vessel 78 and separator 79 are typically returned to still 80 and provide a further source of heat.

Gases leaving still 80 are passed via line 81 and pressure fan 82 to mixer 83 in which they are mixed with substantially anhydrous AlF₃. The mixture is passed through 30 tubular dehydration reactor 84 leading to removal of substantially all the water from the gaseous phase, thereby producing a substantially anhydrous gaseous mixture of HF and SiF₄, together with partially hydrated AlF₃. The gases are separated from the partially hydrated AlF₃ in separator 86 and are transferred to HF absorber 54 via line 87. Partially hydrated AlF₃ produced in dehydration reactor 84 is transferred to AlF₃ drier 89 in which it is heated. Water vapour generated by this heating is optionally condensed and is removed at 91a and 91b, while substantially anhydrous AlF₃ is recycled via line 90 to mixer 83. Exhaust gases from gas turbine 95 are conveniently used for the purpose of heating drier 89.

### EXAMPLE

### Examples 1

### Treatment of Titanium Oxide

A sample of titanium oxide that was heavily contaminated with iron oxide, rendering it of little commercial value, was contact with an aqueous fluorine acid solution containing hydrofluorosilicic acid and HF, in which the ratio of hydrofluorosilicic acid to water was 32:68 by weight, and the ratio of HF to water was 10:90 by weight. After 15 minutes contact at ambient temperature (about 20° C.), the undissolved solid was separated, washed and dried, and was free of iron oxide contamination.

### Example 2

### Treatment of Iron Ore

A sample of iron ore containing about 11% by weight of impurities was treated in a stirred reactor with a similar aqueous fluorine acid solution to that used in Example 1, except that the weight ratio of HF to water was 30:70. After being stirred with this fluorine acid solution for about 15 minutes followed by separating the solids, washing them and drying them, the resultant treated iron ore contained less than 0.3% impurities.

### Example 3

### Treatment of Titanium Iron Sands

Two samples of titanium iron sand from New Zealand were treated in a stirred reactor with a similar aqueous fluorine acid solution to that used in Example 1, except that the weight ratio of HF to water was 35:65. The weight ratio of iron oxide to titanium oxide in the samples was about 55:45. One sample contained about 20% by weight of impurities, mainly silica. The other sample was the same material, except that it had been subjected to mechanical separation to remove gross impurities, and contained about 5% by weight of impurities. After being stirred with the fluorine acid solution for 25-30 minutes followed by separating the solids, washing them and drying them, the resultant treated titanium iron sands had been essentially freed from other metal oxides, leaving the titanium oxide and iron oxide unreacted.

1. A process for treating an inorganic material containing at least two species, to at least partially separate a first species contained in the material from a second species contained in the material, comprising:
treating the material with a fluorine acid solution comprising aqueous hydrofluorosilicic acid and HF, such that the first species is converted to a product selected from the group consisting of a fluoride, a fluorosilicate and mixtures thereof, and such that the second species is at least partly unreacted, and
separating the second species from the product.

2. A process according to claim 1 wherein the fluorine acid solution is saturated with respect to hydrofluorosilicic acid.

3. A process according to claim 1 wherein the HF concentration in the fluorine acid solution is at least about 15% by weight based on the total weight of HF and water present.

4. A process according to claim 1 wherein the HF concentration in the fluorine acid solution is between 15% and 50% by weight based on the total weight of HF and water present.

5. A process according to claim 3 whereby the first species is selected from the group consisting of silica, alumina and mixtures thereof, and does not comprise iron oxide.

6. A process according to claim 1 wherein the HF concentration in the fluorine acid solution is less than about 15% by weight based on the total weight of HF and water present.

7. A process according to claim 1 wherein the HF concentration in the fluorine acid solution is between 1% and 15% by weight based on the total weight of HF and water present.

8. A process according to claim 6 whereby the first species is selected from the group consisting of silica, iron oxides, alumina and mixtures of at least two of these.

9. A process according to claim 1 whereby the mean particle size of the inorganic material is reduced to less than about 2 mm prior to reaction with the fluorine acid solution.

10. A process according to claim 1 wherein the second species represents greater than about 50% by weight of the material.

11. A process according to claim 10 wherein the second species comprises iron oxide, and the process is a process for at least partially purifying the iron oxide.

12. A process according to claim 11 wherein the first species is silica and the concentration of HF in the fluorine acid solution is at least about 15% by weight, based on the total weight of the HF and water present.

13. A process according to claim 10 wherein the second species comprises titanium oxide, and the process is a process for at least partially purifying the titanium oxide.

14. A process according to claim 13 wherein the first species comprises at least one species selected from the group consisting of iron oxide, silica and mixtures thereof, and the concentration of HF in the fluorine acid solution is less than about 15% based on the total weight of the HF and water present.

15. A process according to claim 10 wherein the second species comprises titanium oxide and iron oxide, and the concentration of HF in the fluorine acid solution is at least about 15% by weight, based on the total weight of the HF and water.

16. A process according to claim 1 wherein the separating is by a method selected from the group consisting of settling, filtration, centrifugation, and any combination of these methods.

17. A process according to claim 1 additionally comprising washing the second species with aqueous hydrofluorosilicic acid after the separating.

18. A process according to claim 17 additionally comprising heating the second material, initially to between about 70° C. and about 140° C., and then to between about 250° C. and about 400° C. after the washing.

19. A process according to claim 18 wherein HF and SiF₄ produced by the heating are scrubbed by conventional water wash means.

20. A process according to claim 19 wherein the HF and SiF₄ are recycled for reuse in the process.

21. A process according to claim 1 wherein the inorganic material contains silica and the process releases SiF₄, said process additionally comprising the step of adding the SiF₄ to water in a spray tower to produce aqueous H₂SiF₆ and silica.

22. A process according to claim 21 additionally comprising at least one of the steps of removing the silica from the spray tower, crystallising the silica, and using the aqueous H₂SiF₆ which leaves the tower to wash inorganic material that has been treated by the process.

23. A process according to claim 22 additionally comprising the step of boiling the aqueous H₂SiF₆ used to wash the inorganic material in a still to separate HF, SiF₄ and water vapour from bottoms.

24. A process according to claim 23 wherein the bottoms are removed from the still for a procedure selected from the group consisting of disposal and further processing for recovery of useful metals.

25. A process according to claim 24 wherein the bottoms contain alumina, and the bottoms are heated to a sufficient temperature to sublime aluminium trifluoride.

26. A process according to claim 24 wherein the bottoms are heated in the presence of water under conditions suitable for at least partial hydrolysis of said bottoms.

27. A process according to claim 23 wherein vapours from the still are dried by contacting the vapours with sufficient of a material to remove the water vapour present, said material being substantially unreactive with HF and SiF₄, and being capable of absorbing moisture.

28. A process according to claim 27 wherein the material is selected from the group consisting of aluminium fluoride and calcium fluorosilicate.

29. A process for treating an inorganic material containing at least two species, to at least partially separate a first species contained in the material from a second species contained in the material, comprising:
a) treating the material with a first fluorine acid solution comprising aqueous hydrofluorosilicic acid,
b) treating the material with a second fluorine acid solution comprising hydrofluoric acid (HF), such that the first species is converted to a product selected from the group consisting of a fluoride, a fluorosilicate and mixtures thereof, and such that the second species is at least partly unreacted, and
c) separating the second species from the product, wherein steps a) and b) are conducted in an order selected from the group consisting of a) followed by b) and b) followed by a).
